(19) United States
(12) Patent Application Publication
(10) Pub. No.: US 2018/0189802 A1
(43) Pub. Date: Jul. 5, 2018

(54) SYSTEM, METHOD AND COMPUTER PROGRAM PRODUCT FOR SENSORY SIMULATION DURING PRODUCT TESTING

(71) Applicant: International Business Machines Corporation, Armonk, NY (US)

(72) Inventors: Chris HAMMOND, Houston, TX (US); Temitope Adebimpe Ogunyoku, Nairobi (KE); Jesyka M. Palmer, Nairobi (KE)

(73) Assignee: International Business Machines Corporation

(21) Appl. No.: 15/396,934

(22) Filed: Jan. 3, 2017

(51) Int. Cl. G06Q 30/02; G06T 11/60; G06F 17/30

(52) U.S. Cl. CPC G06Q 30/0201; G06F 17/30023; G06F 17/30867; G06T 11/60

(57) ABSTRACT

A sensory simulation product testing method, system, and computer program product, include extracting at least one pain point associated with a user from a database, correlating at least one of an environment factor, a context factor, and a sentiment factor with the at least one user pain point, and creating an augmented reality in which to immerse the user to test a product based on the at least one of the environment factor, the context factor, and the sentiment factor.

### BACKGROUND

The present invention relates generally to a sensory simulation product testing method, and more particularly, but not by way of limitation, to a system, method, and computer program product for identifying target users, their “pain points” (i.e. problems or issues), context and experience from various data sources, to create an augmented reality for the testing of new products.

Products and services developed to address problems in the markets do not account for the contextual information of users. For example, a product released in the United States market versus a product released in the African market may be required to be designed differently based on differing problems the users face while using the products. The process for collecting and processing contextual information can be cumbersome. To save time, development teams make assumptions about users to achieve progress. However, development teams often develop solutions that are irrelevant and scale poorly.

For example, in a sub-Saharan African context, current usability testing methods for ICT-related technologies is limited to specific demographic(s) who have the means to obtain transport, smartphone devices, computers, and internet. Design researchers often obtain limited feedback about new products and services from users that do not necessarily represent the intended target users. Moreover, lab-based settings might introduce biases to users' feedback due to the users not being in their natural environment when testing a product.

Conventional product techniques have considered requesting that the users “imagine” themselves in a scenario similar to a use case for the product. However, these techniques cannot provide accurate product test results.

### SUMMARY

In an exemplary embodiment, the present invention can provide a computer-implemented sensory simulation product testing method, the method including extracting at least one pain point associated with a user from a database, correlating at least one of an environment factor, a context factor, and a sentiment factor with the at least one user pain point, and creating an augmented reality in which to immerse the user to test a product based on the at least one of the environment factor, the context factor, and the sentiment factor.

One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a sensory simulation product testing method 100;

FIG. 2 exemplarily shows one exemplary embodiment of step 101;

FIG. 3 exemplarily shows one exemplary embodiment of step 102;

FIG. 4 exemplarily depicts an output according to a first exemplary embodiment of step 105;

FIG. 5 exemplarily depicts an output according to a second exemplary embodiment of step 105;

FIG. 6 exemplarily depicts a high-level system architecture for a system 600 that can execute the method 100;

FIG. 7 depicts a cloud computing node according to an embodiment of the present invention;

FIG. 8 depicts a cloud computing environment according to an embodiment of the present invention; and

FIG. 9 depicts abstraction model layers according to an embodiment of the present invention.

### DETAILED DESCRIPTION

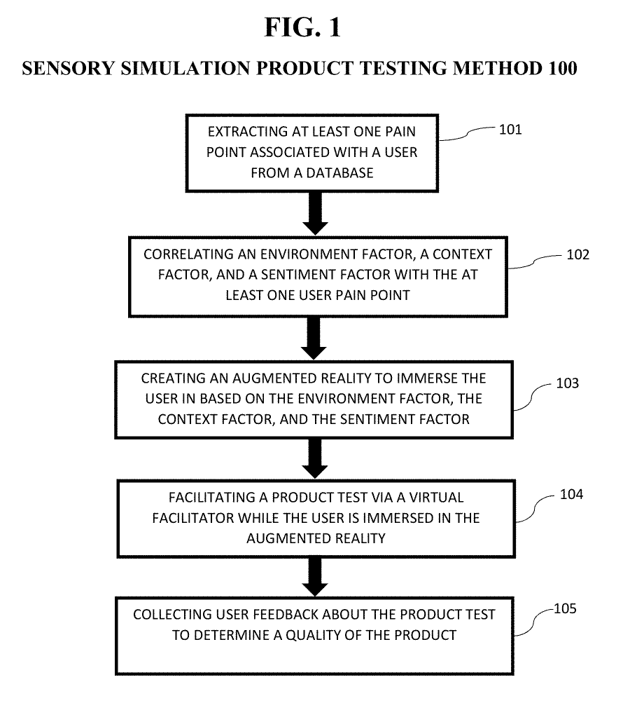

The invention will now be described with reference to FIG. 1-9, in which like reference numerals refer to like parts throughout. It is emphasized that, according to common practice, the various features of the drawing are not necessarily to scale. On the contrary, the dimensions of the various features can be arbitrarily expanded or reduced for clarity.

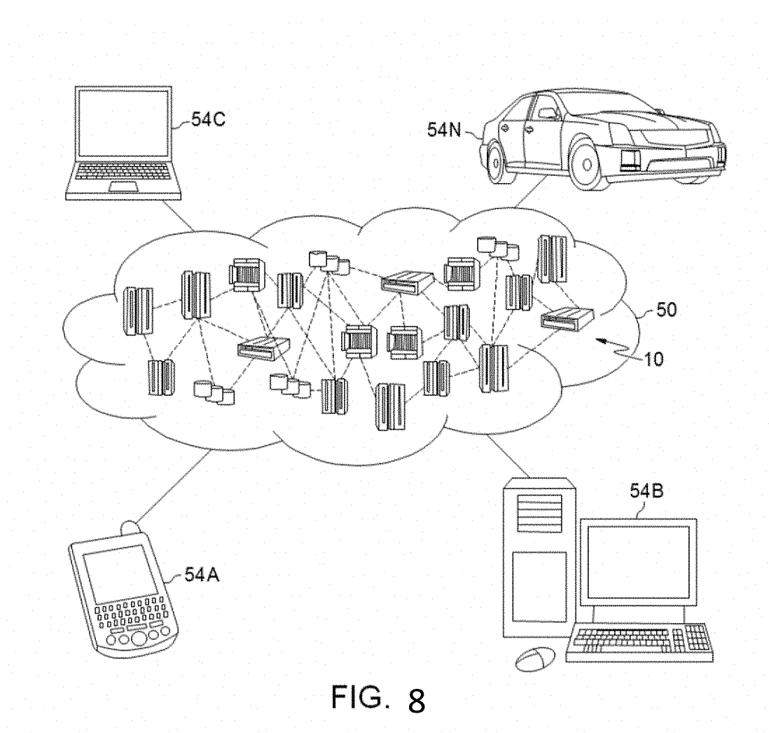

With reference now to the example depicted in FIG. 1, the sensory simulation product testing method 100 includes various steps to identify target users, their so called “pain points” (i.e. problems or issues concerning them) and correlate the pain points with context, environment, and experience from various data sources to create an augmented reality for the testing of new products. As shown in at least FIG. 8, one or more computers of a computer system 12 according to an embodiment of the present invention can include a memory 28 having instructions stored in a storage system to perform the steps of FIG. 1.

Thus, the sensory simulation product testing method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

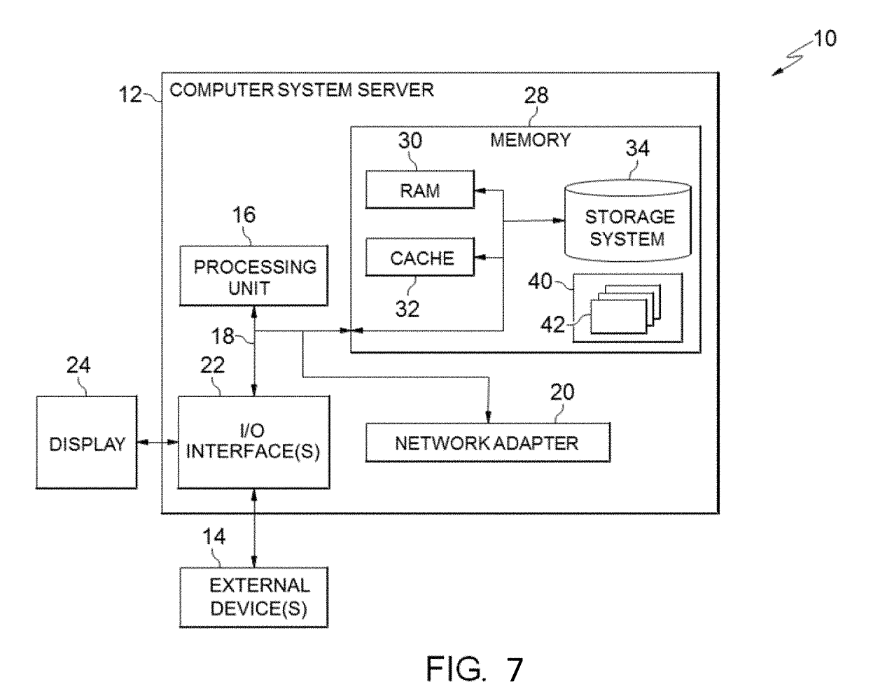

Although one or more embodiments (see e.g., FIGS. 7-9) may be implemented in a cloud environment 50 (see e.g., FIG. 8), it is nonetheless understood that the present invention can be implemented outside of the cloud environment.

In step 101, at least one pain point (e.g., a problem or issues concerning them) of a target user of the product is extracted from a database. The database can include literature about the target user (and/or a user profile created and provided by the user) and searches for recent literature about the topic from online databases. Using Natural Language Processing (NLP) tools, a specialized application programing interface (API) such as Waston API, Alchemy API, etc., step 101 can identify users, at least one pain point of the user, and demographic and geographic background from verified data sources. Step 101 aggregates the pain point(s) from the various data sources in the database and ranks the pain points with the highest frequency of mention.

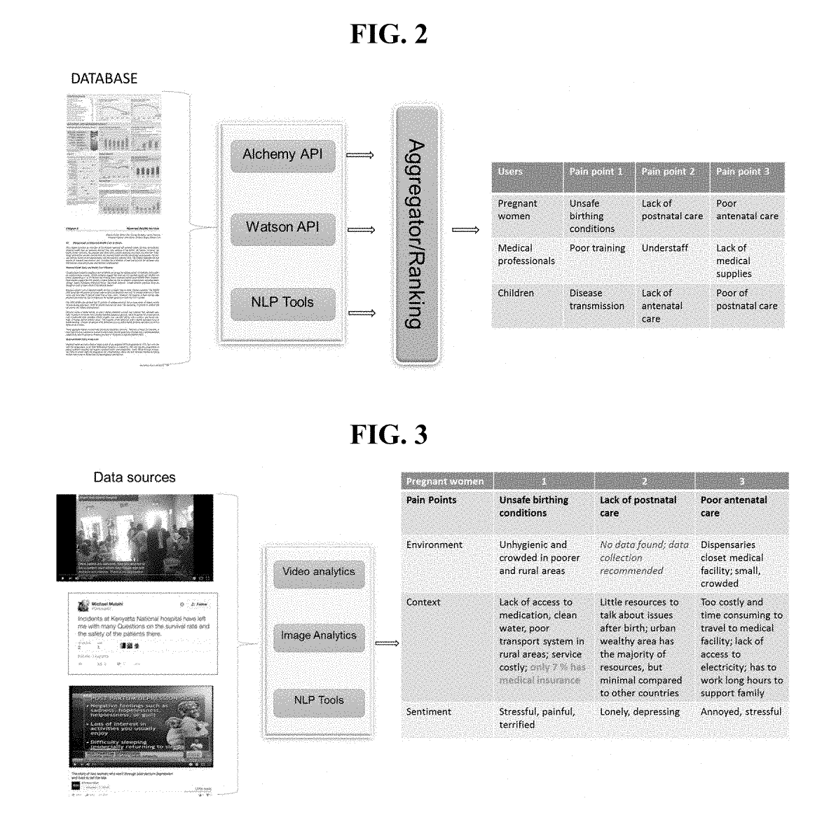

As exemplarily shown in FIG. 2, pain points for a product associated with prenatal care is shown for potential users. Each potential user (i.e., a pregnant women, a medical professional, and children) has pain points extracted and ranked from a database (e.g., data sources).

In step 102, at least one of an environment factor, a context factor, and a sentiment factor are correlated with the pain points of the users using one of NLP tools, image analytics, and video analytics from data sources. For example, pregnant women have a pain point of unsafe birthing conditions (as extracted in step 101), and, in step 102, the “reasons” why the pain point occurs is correlated with the pain point. As exemplarily shown in FIG. 3, by analyzing videos, Twitter™ posts, etc., step 102 can correlate that the environment conditions of “unhygienic and crowded in poorer and rural areas” are a cause of (or correlated with) the pain point. Also, the sentiment of the pain point can be correlated with the pain point. A user's Twitter™ post can be analyzed to correlate a sentiment of “stressful, painful, and terrified” with the pain point.

That is, step 102 searches and identifies contextual data from various sources (e.g. video, social media, image, audio) that relate to the identified pain points. Using image and video analytics and NLP tools, step 102 extracts contextual data and matches it to the user pain points.

In step 103, an augmented reality is created to immerse the user in based on the correlated pain point to environment factor, context factor, and sentiment factor. That is, wearable can be used to measure a user's reaction to the augmented reality and product in the augmented reality environment. A target user using the augmented reality device matches (or is similar to) the demographic and geographic background identified. The augmented reality can be visible to the user through a screen (e.g., in lab testing) or a wearable (e.g., remote testing)

That is, step 103 creates an augmented reality test environment based on the analysis from step 102 for a wearable device/screen that takes the contextual data (e.g. small room, people speaking Swahili, babies crying, etc.) and allows users to see, hear, and participate in the augmented environment while using the product being tested. The wearable device can be connected to the system to measure a user's stress/anxiety levels during testing.

In step 104, the product test in the augmented reality is facilitated by a virtual facilitator embedded in the augmented reality. The facilitator (e.g., a person who facilitates the testing) is a virtual person that mimics a person in the users natural environment (e.g. a nurse) and interacts with the user in their natural language (e.g. Kiswahili, English, etc.). The facilitator is created in the augmented reality based on the environment factors and context factors correlated in Step 103. Thus, the user can test the product not only in the environment as created in step 103 but also with a typical (e.g., familiar) facilitator who would also normally be in the environment with the user while the product is being used. For example, a facilitator can be a nurse in a busy hospital who interacts with the user.

In step 104, after the virtual facilitator gives instruction, the user enters the augmented reality that was created by step 103. For example, the augmented reality can include small crowded room with parents, infants; a nurse comes out every thirty minutes to ask for a patient and the sounds of people speaking in Swahili and Luo about topics related to being in a health facility, babies crying, babies coughing, etc. while the facilitator is still in the sight of the user. While the augmented environment is playing, the user is introduced to the new product and the user is asked to test the product.

It is noted that the wearable device measures the users stress/anxiety levels during testing (e.g., collecting feedback as described later).

In step 105, user feedback about the product test is collected to determine a quality of the product for the environment of the user. That is, a product may work perfectly in a lab setting but the product can have issues during actual use in a typical use setting (e.g., a lab versus a busy hospital). The user is able to provide feedback about the product in an environment similar to an actual use case of the product.

That is, in step 105, the user's audio and interactions with the product during testing are collected and analyzed. Step 105 can automatically calculate the time a user spends on completing each task of the product and the user satisfaction with the product. A system can analyzes the sentiment of the testing environment and the product.

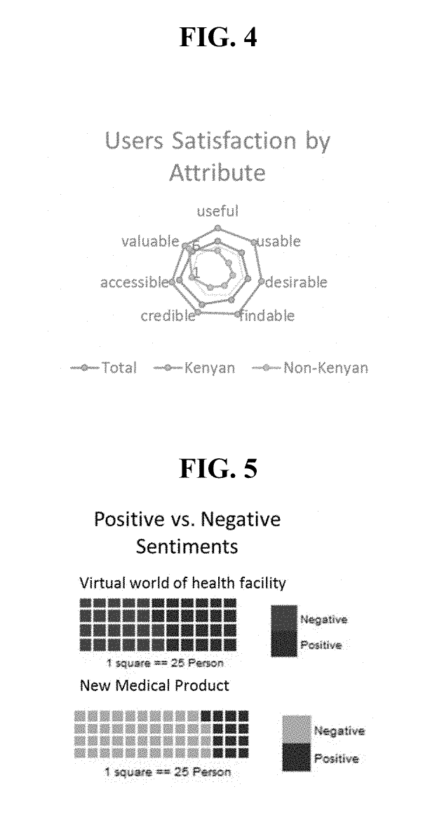

As exemplarily shown in FIGS. 4 and 5, step 105 can create a visual output of the analyzing data. For example, a user satisfaction by attribute as shown in FIG. 4 can be created by analyzes the feedback in step 105. Also, positive and negative sentiments can be graphed for the product or for the augmented reality that was created as shown in FIG. 5. In this manner, step 103 can create a “better” or “more accurate” augmented reality for the user based on the feedback.

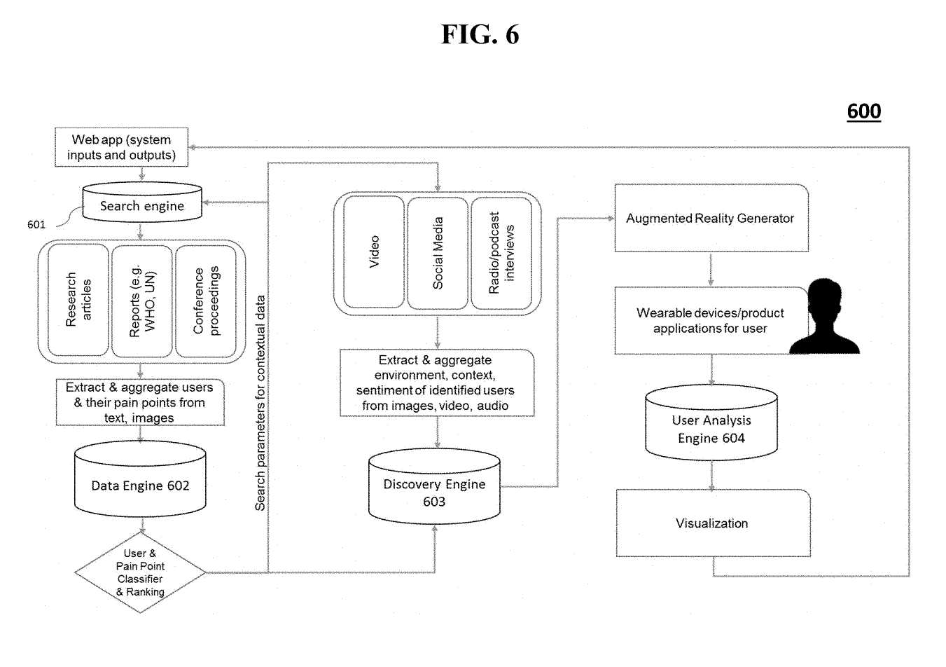

FIG. 6 exemplarily depicts a high-level system architecture for a system 600. The system includes a search engine 501 which can extract at least one pain point associated with the user from research articles, reports, conference proceedings, etc. The pain points are extracted, aggregated, and ranked. The data engine 502 and discovery engine 503 can correlate the pain points with an environment factor, a context factor, and a sentiment factor based on discovered external images, video, social media, etc. The augmented reality generator can generate the augmented reality based on the environment factor, the context factor, and the sentiment factor including creating a facilitator typical to the environment and the product (e.g., if the environment is a hospital and the product is a blood pressure device, the facilitator can be a nurse or a doctor). The user analysis engine 504 can collect and analyze user feedback to determine a quality of the product.

Thereby, the system 60 can use NLP, video analytics, and image analytics to obtain contextual, environment, and sentiment data about users and use the contextual data to create an augmented reality for user testing. The users can test the product in the augmented reality that is facilitated by a facilitator (e.g., a person likely to be facilitating the product use in reality) so that the most natural and honest feedback about a product can be obtained. While the example above was directed to medical care, any product in any environment (e.g., police, firefighter, education, construction, etc.) can be tested.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.
Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 7, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 7, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 8, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 8 are intended to be illustrative only and that computing nodes 10 and cloud computing environment 50 can communicate with any type of computerized circuit over any type of network and/or network addressable connection (e.g., using a web browser).

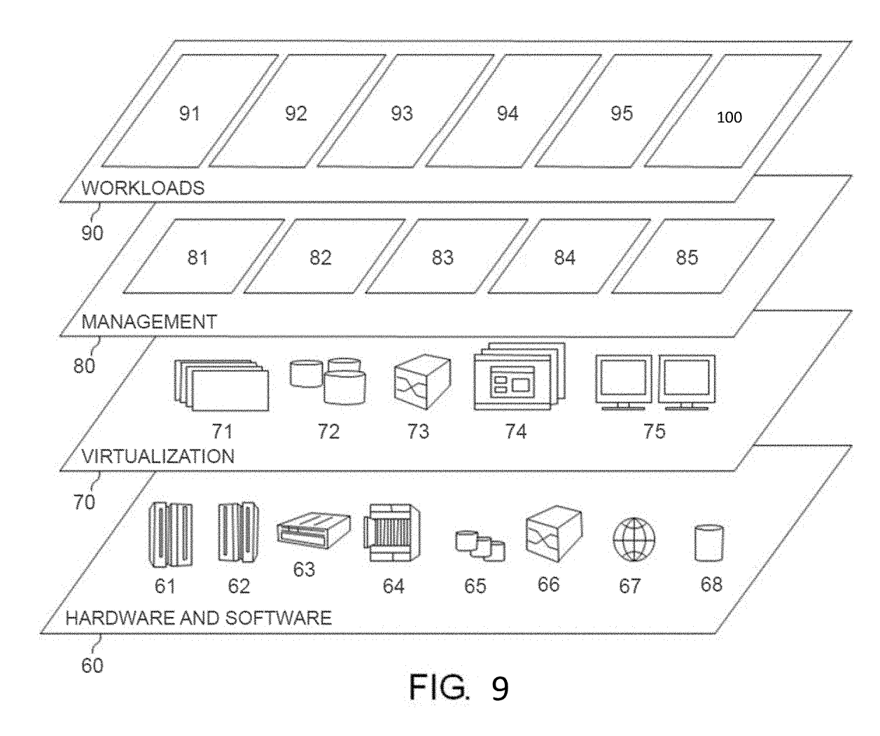

Referring now to FIG. 9, an exemplary set of functional abstraction layers provided by cloud computing environment 50 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the sensory simulation product testing method 100.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented sensory simulation product testing method, the method comprising:
extracting at least one pain point associated with a user from a database;
correlating at least one of an environment factor, a context factor, and a sentiment factor with the at least one user pain point; and
creating an augmented reality in which to immerse the user to test a product based on the at least one of the environment factor, the context factor, and the sentiment factor.

2. The computer-implemented method of claim 1, further comprising facilitating the product test via a virtual facilitator embedded in the augmented reality while the user is immersed in the augmented reality.

3. The computer-implemented method of claim 1, wherein the creating creates a facilitator to facilitate the product test based on an individual associated with the environment factor.

4. The computer-implemented method of claim 1, wherein the extracting extracts the at least one pain point from the database by using at least one of Natural Language Processing (NLP), image analytics, and video analytics.

5. The computer-implemented method of claim 1, wherein the extracting extracts a plurality of pain points and aggregates and ranks the plurality of pain points of the user based on demographic and geographic background data in the database.

6. The computer-implemented method of claim 1, wherein the correlating correlates the at least one of the environment factor, the context factor, and the sentiment factor with the at least one user pain point by determining environment, context, and sentiment causes of the at least one user pain point from a plurality of data sources including social media, video sources, and audio sources.

7. The computer-implemented method of claim 1, further comprising collecting user feedback about the product test to determine a quality of the product.

8. The computer-implemented method of claim 7, wherein a virtual reality device collects the user feedback.

9. The computer-implemented method of claim 1, wherein the extracting extracts a plurality of pain points associated with the user and ranks the plurality of pain points such that the augmented reality is created to reflect the pain points ranked highest.

10. The computer-implemented method of claim 2, wherein the facilitator comprises an individual associated with the product and the environment factor.

11. The computer-implemented method of claim 1, embodied in a cloud-computing environment.

12. A computer program product for sensory simulation product testing, the computer program product comprising a computer-readable storage medium having program instructions embodied therewith, the program instructions executable by a computer to cause the computer to perform:
extracting at least one pain point associated with a user from a database;
correlating at least one of an environment factor, a context factor, and a sentiment factor with the at least one user pain point; and
creating an augmented reality in which to immerse the user to test a product based on the at least one of the environment factor, the context factor, and the sentiment factor.

13. The computer program product claim 12, further comprising facilitating the product test via a virtual facilitator embedded in the augmented reality while the user is immersed in the augmented reality.

14. The computer program product claim 12, wherein the creating creates a facilitator to facilitate the product test based on an individual associated with the environment factor.

15. The computer program product claim 12, wherein the extracting extracts the at least one pain point from the database by using at least one of Natural Language Processing (NLP), image analytics, and video analytics.

16. The computer program product claim 12, wherein the extracting extracts a plurality of pain points and aggregates and ranks the plurality of pain points of the user based on demographic and geographic background data in the database.

17. The computer program product claim 12, wherein the correlating correlates the at least one of the environment factor, the context factor, and the sentiment factor with the at least one user pain point by determining environment, context, and sentiment causes of the at least one user pain point from a plurality of data sources including social media, video sources, and audio sources.

18. The computer program product claim 12, further comprising collecting user feedback about the product test to determine a quality of the product.

19. A sensory simulation product testing system, said system comprising:
a processor; and
a memory, the memory storing instructions to cause the processor to perform:
extracting at least one pain point associated with a user from a database;
correlating at least one of an environment factor, a context factor, and a sentiment factor with the at least one user pain point; and
creating an augmented reality in which to immerse the user to test a product based on the at least one of the environment factor, the context factor, and the sentiment factor.

20. The system of claim 19, embodied in a cloud-computing environment.
